(19) United States
(12) Patent Application Publication
(10) Pub. No.: US 2008/0030122 A1
(43) Pub. Date: Feb. 7, 2008

(54) Electron emitting element, manufacturing method for electron emitting element, and display device having electron emitting element

(76) Inventor: Masashi Yamage, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/708,343

(22) Filed: Feb. 21, 2007

(30) Foreign Application Priority Data
Feb. 22, 2006 (JP) 2006-045472

(51) Int. Cl. H01J 1/62; H01J 19/02; H01J 9/02

(52) U.S. Cl. 313/495; 313/346 R; 445/51

(57) ABSTRACT

An electron emitting element includes a substrate, an electrically conductive layer located on the substrate and formed with a protrusion or a recess, and an electron emitting layer formed over the protrusion or the recess on the conductive layer and having a plurality of linear conductors, a height of the protrusion or a depth of the recess being greater than a thickness of the electron emitting layer.

### CROSS-REFERENCE TO RELATED APPLICATIONS

This application is based upon and claims the benefit of priority from prior Japanese Patent Application No. 2006-045472, filed Feb. 22, 2006, the entire contents of which are incorporated herein by reference.

### BACKGROUND OF THE INVENTION

1. Field of the Invention

The present invention relates to an electron emitting element used in a display device or the like, a manufacturing method for an electron emitting element, and a display device having an electron emitting element, whereby uniform electron emission is ensured, in particular.

2. Description of the Related Art

A field emission display (FED) that uses an electron emitting element is known as one type of display device. As disclosed in Jpn. Pat. Appln. KOKAI Publication No. 2004-186015 (FIG. 1), there is known a technology in which carbon-based emitters, such as carbon nanotubes (CNTs) that have so small a diameter that electric fields are easily concentrated on them, are utilized for the electron emitting element of the FED. Generally, in the electron emitting element of this type, a cathode electrode layer and a carbon-based emitter growing catalyst layer are formed flat on a glass substrate, and the carbon-based emitters are generated on the upper surface of the carbon-based emitter growing catalyst layer by the CVD method, printing method, etc. The carbon-based emitter growing catalyst layer is unnecessary when the printing method is used.

However, the electron emitting element described above has the following problem. Specifically, it is difficult to equalize the respective lengths of a large number of CNTs, if any, to be formed by the CVD or printing method. In some cases, therefore, the amount of electrons emitted from the many CNTs on the flat carbon-based emitter growing catalyst layer may be subject to dispersion.

### BRIEF SUMMARY OF THE INVENTION

An aspect of the invention is;

an electron emitting element which comprises: a substrate;

an electrically conductive layer located on the substrate and formed with a protrusion or a recess; and

an electron emitting layer formed over the protrusion or the recess on the conductive layer and having a plurality of linear conductors, a height of the protrusion or a depth of the recess being greater than a thickness of the electron emitting layer.

An aspect of the invention is;

a manufacturing method for an electron emitting element, which comprises:

forming an electrically conductive layer having a protrusion or a recess on a substrate; and

forming an electron emitting layer having a plurality of linear conductors over the protrusion or the recess on the conductive layer,

a height of the protrusion or a depth of the recess being greater than a thickness of the electron emitting layer.

An aspect of the invention is;

a display device which comprises:

an electron emitting element having a substrate, an electrically conductive layer located on the substrate and formed with a protrusion or a recess, and an electron emitting layer formed over the protrusion or the recess on the conductive layer and having a plurality of linear conductors, a height of the protrusion or a depth of the recess being greater than a thickness of the electron emitting layer; and

a display section which is caused to glow by an electron emitted from the electron emitting element.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawing, which are incorporated in and constitute a part of the specification, illustrate embodiments of the invention, and together with the detailed description of the embodiments given below, serve to explain the principles of the invention.

FIG. 1 is a perspective view showing a part of an image display device according to an embodiment of the invention;

FIG. 2 is a sectional view enlargedly showing a principal part of the image display device;

FIG. 3 is a perspective view enlargedly showing the principal part of the image display device;

FIG. 4 is a sectional view showing a catalyst layer forming process in a manufacturing method for an electron emitting element according to the first embodiment;

FIG. 5 is a sectional view showing a gate forming process in the manufacturing method;

FIG. 6 is a sectional view showing an emitter hole forming process in the manufacturing method;

FIG. 7 is a sectional view showing an emitting layer forming process in the manufacturing method; and

FIG. 8 is a sectional view showing an electron emitting element according to another embodiment of the invention.

### DETAILED DESCRIPTION OF THE INVENTION

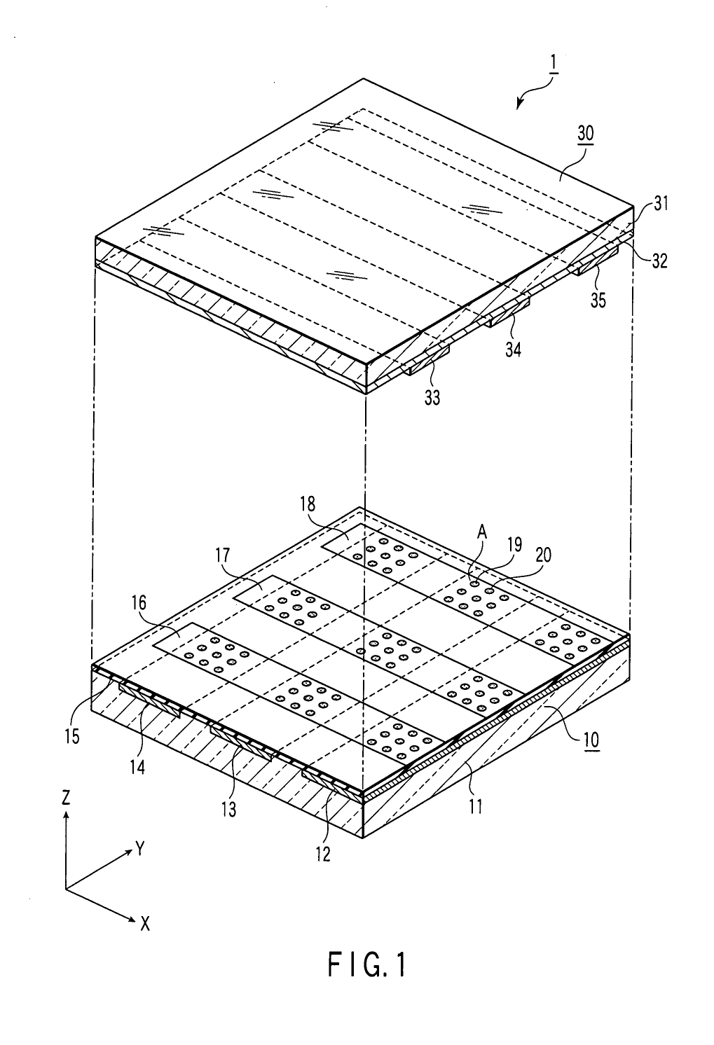

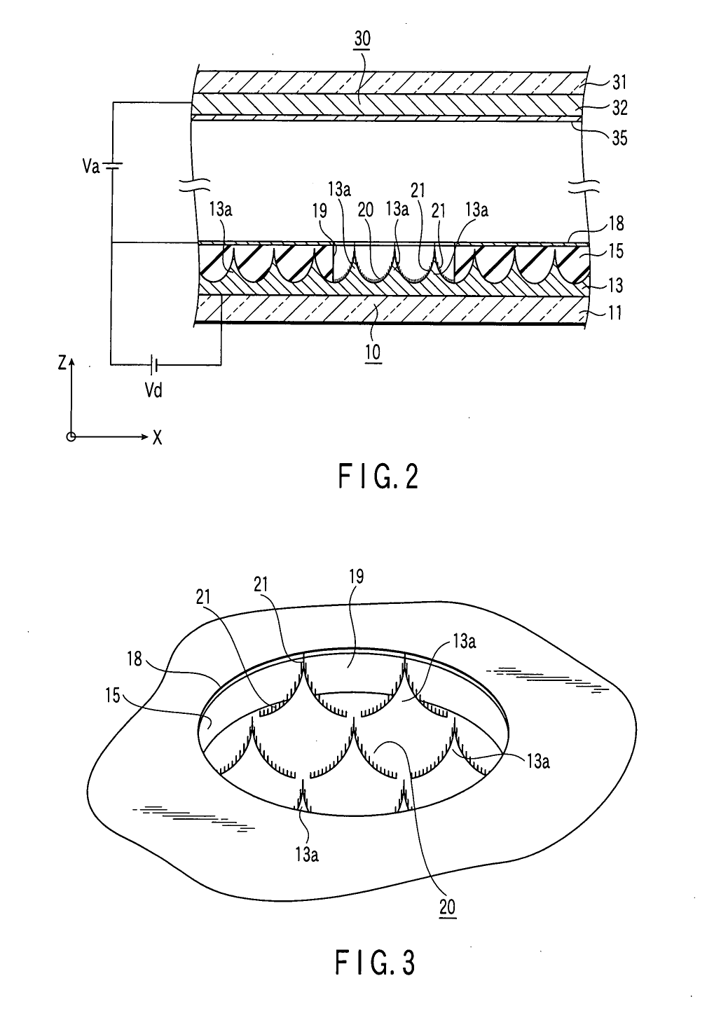

An image display device 1 according to an embodiment of the present invention will now be described with reference to FIGS. 1 to 3. FIG. 1 is a perspective view showing a portion corresponding to one pixel of the image display device 1. FIG. 2 is an enlarged sectional view showing a portion A of the device 1 of FIG. 1, and FIG. 3 is an enlarged sectional view showing the portion A of an electron emitting element 10 of FIG. 1. Arrows X, Y and Z in FIGS. 1 and 2 indicate three perpendicular directions, individually.

As shown in FIG. 1, the image display device 1 comprises the electron emitting element 10 and a display section 30 that is caused to glow by an electron emitted from the electron emitting element 10. The electron emitting element 10 and the display section 30 are joined opposite each other with a predetermined gap secured therebetween.

The electron emitting element 10 shown in FIGS. 1 and 2 comprises a cathode substrate 11, electrically conductive layers 12, 13 and 14 formed on the cathode substrate 11, a dielectric layer 15 formed on the conductive layers 12 to 14, and gate electrodes 16, 17 and 18 formed on the dielectric layer 15. Emitter holes 19 are formed in the dielectric layer 15 and the gate electrodes 16 to 18. In the emitter holes 19, a carbon layer 20 is formed on the conductive layers 12 to 14. The cathode substrate 11 is made of glass or silicon and has a necessary predetermined area for image display.

In this case, the three conductive layers 12 to 14, e.g., three in number, are formed in parallel with one another on the cathode substrate 11 that corresponds to one pixel. For example, the conductive layers 12 to 14 are made of a catalytic metal, such as nickel, and are each in the form of a rectangle that extends long in the Y-direction. Further, a plurality of protrusions 13a are formed on those surfaces of the conductive layers 12 to 14 which face the display section 30. The protrusions 13a are arranged in a matrix such that their respective tips are spaced at intervals of about 50 μm. Each protrusion 13a is formed having the shape of a spindle. Each protrusion 13a is substantially in the form of a cone with a pointed tip, and the edge of its profile is arcuate, as shown in FIG. 2. The height of each protrusion 13a is adjusted to about 20 μm, which is larger enough than the length of each of carbon nanotubes (CNTs) 21 (mentioned later). Thus, the height of each protrusion 13a is larger enough than the thickness of the carbon layer 20.

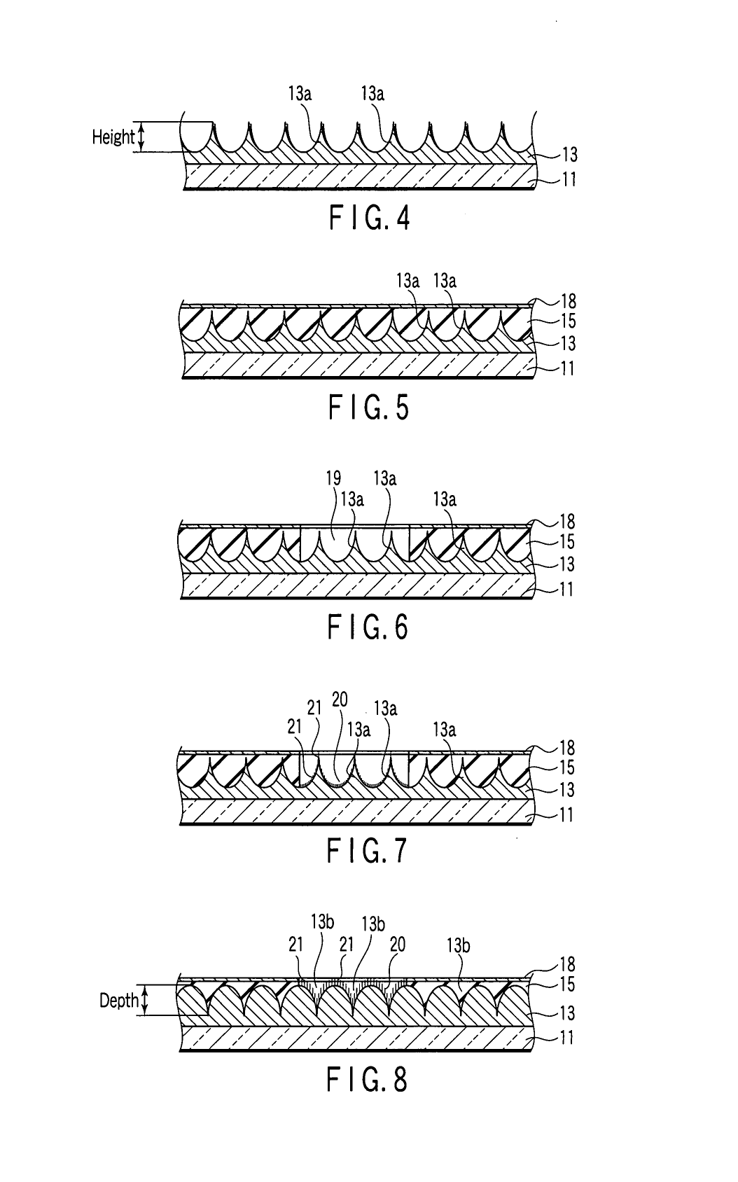

As mainly shown in FIG. 4, the height of each protrusion 13a is the height of its tip above the deepest bottom portion between each two adjacent protrusions 13a.

As shown in FIGS. 1 and 2, the dielectric layer 15, which is made of silicon oxide or the like, is formed on the respective upper surfaces of the cathode substrate 11 and the conductive layers 12 to 14. The three gate electrodes 16 to 18 are made of a metal, such as aluminum, and are each in the form of a rectangle that extends long in the X-direction. They are located in positions corresponding to three-color phosphors 33 to 35 (mentioned later), respectively. The gate electrodes 16 to 18 are connected to a driver circuit and matrix-controlled.

As shown in FIG. 1, a plurality of circular emitter holes 19 are formed individually in regions where the gate electrodes 16 to 18, dielectric layer 15, and conductive layers 12 to 14 cross and overlap one another. In this case, as shown in FIG. 2, the emitter holes 19 are formed as only the gate electrodes 16 to 18 and the dielectric layer 15 are removed by etching or the like.

As shown in FIG. 3, several protrusions 13a correspond to each emitter hole 19.

In the emitter holes 19, the carbon layer 20 is uniformly formed on the conductive layers 12 to 14. The carbon layer 20 is composed of a large number of CNTs 21 that are grown and raised like the hair of a brush in the Y-direction toward the display section 30. Each CNT 21 is a rolled cylinder of a graphene sheet. The CNT 21 has a diameter of about 50 nm and a length of about 1 μm. It has so high an allowable current density that it can emit an electron if only a low voltage is applied to it in a decompression chamber. The respective tips of the CNTs 21 that are generated on the top of each protrusion 13a are situated below the gate electrodes 16 to 18.

As shown in FIGS. 1 and 2, on the other hand, the display section 30 comprises an anode substrate 31, an anode electrode 32 formed on the anode substrate 31, and the phosphors 33, 34 and 35 of three colors R, G and B applied to a surface of the anode electrode 32.

In order to improve the effect of sealing between the anode substrate 31 and the cathode substrate 11, in this case, the anode substrate 31 is made of the same transparent material, e.g., glass, as the cathode substrate 11. Further, the anode electrode 32 is formed on that surface of the anode substrate 31 which faces the cathode substrate 11, and is made of a metal such as aluminum. The anode electrode 32 is connected to the driver circuit. On the other hand, the three-color phosphors 33 to 35 are each in the form of a rectangle that extends long in the X-direction. They are located corresponding to the gate electrodes 16 to 18, individually.

The electron emitting element 10 and the display section 30 are joined together with the predetermined gap secured therebetween by spacers (not shown). This gap is satisfactorily kept in a high-vacuum state by a getter (not shown).

A manufacturing method for the image display device 1 according to the foregoing embodiment of the invention will now be described with reference to FIGS. 4 to 7.

First, a nickel plate is worked by electroforming, whereupon the protrusions 13a are formed in a matrix. Then, the nickel plate having the protrusions 13a is mounted on the cathode substrate 11 that is made of glass. Thus, the conductive layers 12 to 14 are formed as catalyst layers on the cathode substrate 11. FIG. 4 illustrates this process.

Then, the dielectric layer 15 is formed over the conductive layers 12 to 14 and the whole upper surface of the cathode substrate 11 on which the conductive layers 12 to 14 are not formed. Subsequently, a surface of the dielectric layer 15 is filmed with a metal such as aluminum, which is different from the catalytic metal used for the conductive layers 12 to 14, by sputtering or the like, whereupon the gate electrodes 16 to 18 are formed. FIG. 5 illustrates this process.

Further, the emitter holes 19 are formed in predetermined positions so that the catalytic metal is exposed through the gate electrodes 16 to 18 and the dielectric layer 15. FIG. 6 illustrates this process.

After the emitter holes 19 are formed, the cathode substrate 11 is introduced into a decompression chamber, and a gas mixture of methane and hydrogen is decomposed by plasma, whereupon the CNTs 21 are formed on the exposed conductive layers 12 to 14. FIG. 7 illustrates this process.

The conductive layers 12 to 14 are formed of a catalytic metal such as nickel, for example. Since the conductive layers 12 to 14 serve as catalyst layers, in this case, the CNTs 21 can be formed directly thereon by the aforementioned method. Further, the plasma is microwave plasma, and an electric field is previously formed at right angles to the surfaces of the conductive layers 12 to 14 in order to orient the growing CNTs 21 uniformly. Thus, in the emitter holes 19 through which the conductive layers 12 to 14 are exposed, a large number of CNTs 21 are formed like the hair of a brush on the conductive layers 12 to 14. The electron emitting element 10 is completed in this manner. The height of each protrusion 13a is larger enough than the length of each CNT 21, and its side face is arcuated so that its tip is sharp, as shown in FIG. 7. Therefore, the surface of the formed carbon layer 20, like those of the conductive layers 12 to 14, has a plurality of protrusions.

On the other hand, the anode electrode 32 is formed on the anode substrate 31 that is made of a transparent material such as glass, and the phosphors 33 to 35 are applied to the anode electrode 32, whereupon the display section 30 is manufactured.

With the predetermined gap secured by the spacers, moreover, the respective peripheries of the cathode substrate 11 and the anode substrate 31 are joined together with a sealant. Thus, the electron emitting element 10 and the display section 30 are joined together, whereby the image display device 1 is completed (refer to FIG. 1 or 2 for this process).

The operation of the image display device 1 according to the present embodiment will now be described with reference to FIGS. 1 and 2.

When predetermined voltages Vd and Va (FIG. 2) are applied individually to the anode electrode 32, conductive layers 12 to 14 as cathode electrodes, and gate electrodes 16 to 18, electric fields are concentrated on the respective tips of the CNTs 21 that are grown on the tips of the protrusions 13a, whereupon electrons are emitted. The electrons are guided by the gate electrodes 16 to 18 and land on the anode electrode 32 that is coated with the phosphors 33 to 35. Thereupon, the phosphors 33 to 35 are excited to luminescence. This luminescence causes a desired image to be displayed through the transparent anode substrate 31. In this case, the luminescence can be controlled by matrix-controlling the voltages to be applied to the gate electrodes 16 to 18, so that each pixel can serve for gradation display.

According to the present embodiment, the electron emitting element 10 produces the following effects

Satisfactory field emission characteristics can be obtained by utilizing the CNTs 21. Since the protrusions 13a of a metallic catalyst are formed so that the CNTs 21 are generated on their respective upper surfaces, moreover, the CNTs 21 can uniformly emit electrons. More specifically, if the CNTs 21 are densely bunched, the electric fields cannot be readily concentrated, so that electrons cannot be emitted with ease. Since the conductive layers 12 to 14 are provided with the protrusions 13a to facilitate the concentration of the electric fields, so that electrons can be emitted with ease. In the present embodiment, moreover, the length of each CNT 21 is 1 μm, and the height of each protrusion 13a is adjusted to 20 μm, which is larger enough than the thickness of the carbon layer 20. Accordingly, the amount of electron emission depends on the shape of each protrusion 13a, not on that of each CNT 21. If the CNTs 21 are irregular in length, therefore, the amount of electrons emitted from electron emitting element can be made uniform by equalizing the protrusions 13a in shape.

It is hard, moreover, to form the CNTs 21 individually on specific portions, such as the tips of the protrusions 13a. In the present embodiment, however, the CNTs 21 are uniformly formed over the entire area of the conductive layers 12 to 14 in the emitter holes 19 by the plasma or thermal CVD method, so that the carbon layer 20 can be formed easily and securely. Since the conductive layers 12 to 14 are formed as the cathode electrodes using a catalytic metal such as nickel, moreover, the carbon layer 20 can be formed directly on their respective upper surfaces. Since the CNTs 21 are grown on the exposed parts of the conductive layers of the catalytic metal, furthermore, the region for the formation of the carbon layer 20 can be easily restricted by patterning the conductive layers 12 to 14 and the emitter holes 19 to be formed.

According to the present embodiment, moreover, a plurality of protrusions 13a are arranged for each emitter hole 19, so that position alignment is easier than in the case where one protrusion is provided for each emitter hole 19. Since the amount of electrons emitted from the respective tips of the protrusions 13a is equated, furthermore, the image properties can be prevented from being worsened by differences in height between the protrusions 13a.

Although the conductive layers 12 to 14 are made of nickel according to the embodiment described above, they may alternatively be formed of any other catalytic metal, such as cobalt, iron, or an alloy of these metals. Further, the conductive layers 12 to 14 may be formed on the cathode substrate 11 by sputtering or any other method than electroforming so that the protrusions 13a can be also formed by lithography or etching.

Instead of the protrusions 13a formed in the aforementioned manner, moreover, recesses 13b may be formed in the conductive layers 12 to 14 by a predetermined method, as shown in FIG. 8, such that CNTs (carbon nanotubes) can be formed over and along the recesses 13b by the aforementioned method. In this case, the same effect can be obtained as in the case where the protrusions 13a are formed.

The depth of each recess principally indicates a distance from the surface position of the conductive layer 12, 13 or 14 to the deepest portion of the recess.

Although the CNTs 21 are given as examples of linear conductors according to the embodiment described above, they may be replaced with graphitic materials, such as graphitic nanotubes, graphite nanofibers, etc., or any other materials, such as amorphous films, diamond, diamond-like carbon, silicon nanowires, etc. According to the present embodiment, moreover, electric fields can be concentrated even though the CNTs 21 are thickened, and electrons can be easily emitted even if the CNTs 21 are oriented irregularly. Therefore, the carbon layer 20 may be formed by the thermal CVD method or the like in place of the plasma CVD method.

Although the gate electrodes 16 to 18 are matrix-controlled for scanning according to the present embodiment, the invention may be also applied to, for example, a two-pole structure in which the anode electrode 32 is used for scanning. Further, the electron emitting element according to the present embodiment is also applicable to various other devices than an FED.

The present invention is not limited directly to the embodiment described above, and its components may be embodied in modified forms without departing from the spirit of the invention. Further, various inventions may be made by suitably combining a plurality of components described in connection with the foregoing embodiment. For example, some of the components according to the embodiment may be omitted. Furthermore, components according to different embodiments may be combined as required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of general inventive concept as defined by appended claims and their equivalents.

What is claimed is:

1. An electron emitting element comprising:
a substrate;
an electrically conductive layer located on the substrate and formed with a protrusion or a recess; and
an electron emitting layer formed over the protrusion or the recess on the conductive layer and having a plurality of linear conductors,
a height of the protrusion or a depth of the recess being greater than a thickness of the electron emitting layer.

2. An electron emitting element according to claim 1, wherein the linear conductors are carbon nanotubes.

3. An electron emitting element according to claim 1, wherein the linear conductors are graphite nanofibers.

4. An electron emitting element according to claim 1, wherein the linear conductors are graphitic nanotubes.

5. An electron emitting element according to claim 1, wherein the conductive layer contains iron, nickel, cobalt, or an alloy that contains at least one of said metals.

6. An electron emitting element according to claim 1, wherein the protrusion is formed having the shape of a spindle.

7. A manufacturing method for an electron emitting element, comprising:
forming an electrically conductive layer having a protrusion or a recess on a substrate; and
forming an electron emitting layer having a plurality of linear conductors over the protrusion or the recess on the conductive layer,
a height of the protrusion or a depth of the recess being greater than a thickness of the electron emitting layer.

8. A manufacturing method for an electron emitting element according to claim 7, wherein the conductive layer is a catalyst layer, and the electron emitting layer is formed directly on the conductive layer.

9. A display device comprising:
an electron emitting element having a substrate, an electrically conductive layer located on the substrate and formed with a protrusion or a recess, and an electron emitting layer formed over the protrusion or the recess on the conductive layer and having a plurality of linear conductors, a height of the protrusion or a depth of the recess being greater than a thickness of the electron emitting layer; and
a display section which is caused to glow by an electron emitted from the electron emitting element.

10. A display device according to claim 9, wherein the linear conductors are carbon nanotubes.

11. A display device according to claim 9, wherein the linear conductors are graphite nanofibers.

12. A display device according to claim 9, wherein the linear conductors are graphitic nanotubes.

13. A display device according to claim 9, wherein the conductive layer contains iron, nickel, cobalt, or an alloy that contains at least one of said metals.
